(19) United States
(12) Patent Application Publication
(10) Pub. No.: US 2012/0259866 A1
(43) Pub. Date: Oct. 11, 2012

(54) SYSTEM AND METHOD FOR AUTOMATICALLY EVALUATING CONTRIBUTOR PERFORMANCE

(76) Inventors: L. Suzie AUSTIN, Broomfield, CO (US); Kevin BRIDGES, Westminster, CO (US); James G. DAVIDSON, Reston, VA (US); Rebecca DILWORTH, Westminster, CO (US); David T. RAGER, Lakewood, CO (US); James T. RIDGEWAY, II, Falls Church, VA (US)

(21) Appl. No.: 13/315,924

(22) Filed: Dec. 9, 2011

Related U.S. Application Data
(60) Provisional application No. 61/472,070, filed on Apr. 5, 2011.

(51) Int. Cl. G06F 17/30

(52) U.S. Cl. 707/748; 707/756; 707/E17.009; 707/E17.045

(57) ABSTRACT

A computer system automatically evaluates the performance of a content generator using content created by the content generator and user and content generator interactions with the content. Specifically, the system analyzes data regarding the content, e.g., a peer-review quality score, and analyzes data regarding user and/or content generator interactions with the content, e.g., website comments regarding the content. In addition, the system considers user and content generator interactions with the content on third-party websites, e.g., the number of Facebook® “likes” or other social media actions. The system applies rules to assign values to various data points (e.g., a value of 0.3 may be assigned for each Facebook® “like” by a user). The rules may also define weighing components to incentivize particular actions. Weighed values are summed to evaluate each content generator. The scores for each content generator may be compared to create a content generator ranking.

### CROSS REFERENCE TO RELATED APPLICATIONS

The present application claims priority to U.S. Provisional Patent Application No. 61/472,070, filed on Apr. 5, 2011, the content of which is incorporated by reference in its entirety.

### TECHNICAL FIELD

Several embodiments of the invention relate generally to publishing content online and in particular to automatically evaluating the performance of online content generators.

### BACKGROUND/SUMMARY

In recent years, there has been a significant increase in the amount of content created. At the same time, use of the internet to facilitate communications has also grown. According to some embodiments of the invention, a computer system obtains a first set of data relating to online content created by a content generator. The computer system also obtains a second set of data corresponding to user interactions with a website hosting the online content, as well as a third set of data corresponding to user and content generator interactions with the online content on third-party websites. The computer system analyzes the first set of data, the second set of data, and the third set of data using a set of rules and determines a level of positive contribution based on the analysis of the first set of data, the second set of data, and the third set of data using the set of rules.

More specifically, in some embodiments, a computer system automatically evaluates the performance of a content generator. The computer system obtains and analyzes information regarding online content generated by a content generator, such as a quality review score by peer reviewers. The computer system also obtains and analyzes information regarding user interactions with the online content on a webpage hosting the online content, such as the number of page views. The computer system may further analyze interactions by a user and/or the content generator with the content on third party websites, such as the number of Facebook® “likes” or Twitter® “tweets” referring to the online content. The computer system uses a set of rules to assign values to the various data points (e.g., a value of 1.5 may be assigned to each Facebook® “like” by a user) and also multiplies the values by weighting factors. The weighted values are added together for a total content generator score, which reflects an evaluation of the performance of the content generator. The total scores for various content generators may be compared in order to evaluate and/or rank each content generator relative to other content generators.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a networked environment in which embodiments of the present invention may operate.

FIG. 2A illustrates an exemplary computer in accordance with embodiments of the present invention.

FIG. 2B illustrates an exemplary computer server in accordance with embodiments of the present invention.

FIG. 3 depicts a flow chart illustrating aspects of embodiments of the present invention.

FIG. 4 depicts a flow chart illustrating steps envisioned by embodiments of the present invention for obtaining data.

FIG. 5 depicts a flow chart illustrating steps envisioned by embodiments of the present invention for obtaining data.

FIG. 6 depicts a flow chart illustrating steps envisioned by embodiments of the present invention for obtaining data.

FIG. 7 depicts a flow chart illustrating steps envisioned by embodiments of the present invention for obtaining data.

FIG. 8 depicts a flow chart illustrating aspects of embodiments of the present invention for aggregating data.

FIG. 9 depicts a flow chart illustrating steps envisioned by embodiments of the present invention for analyzing data.

FIG. 10 depicts a flow chart illustrating steps envisioned by embodiments of the present invention for analyzing data and determining content generator compensation.

FIG. 11 depicts a tiered-program of content generator compensation according to embodiments of the present invention.

FIG. 12 depicts a flow chart illustrating steps by which a user may modify rules for content generator compensation according to embodiments of the present invention.

FIG. 13 depicts a flow chart illustrating steps for distributing content generator compensation according to embodiments of the present invention.

FIG. 14 depicts a page in which an operator may alter settings of an automated system according to embodiments of the present invention.

### DETAILED DESCRIPTION

According to several embodiments of the present invention, an automated system evaluates content generators (e.g., authors) based on the quality of content created by the content generators and on the impact of the content on users. The automated system also evaluates content generators based on efforts to publicize their content or to refer users to related content.

In some embodiments, an automated system obtains data related to online content and determines the level of positive contribution provided by the content generator, based on the obtained data. Specifically, the automated system may obtain data about the content itself, e.g., a quality review score from one or more peer content generators. In addition, the automated system may obtain data related to user interactions with the content, such as the number of page views. The automated system may further obtain data corresponding to interactions with the content by users or by content generators, such as Facebook® “likes” or Twitter® “tweets” regarding the content. The automated system may then apply a set of rules to the obtained data that, in some embodiments, gives more importance or weight to certain data points and less or no importance to other data points. The automated system may also create a report indicating, for example, the total level of positive contribution by the content generator. The automated system may include programming that permits an operator to change the set of rules and quickly update the evaluation of the content generator's level of positive contribution using the changed set of rules.

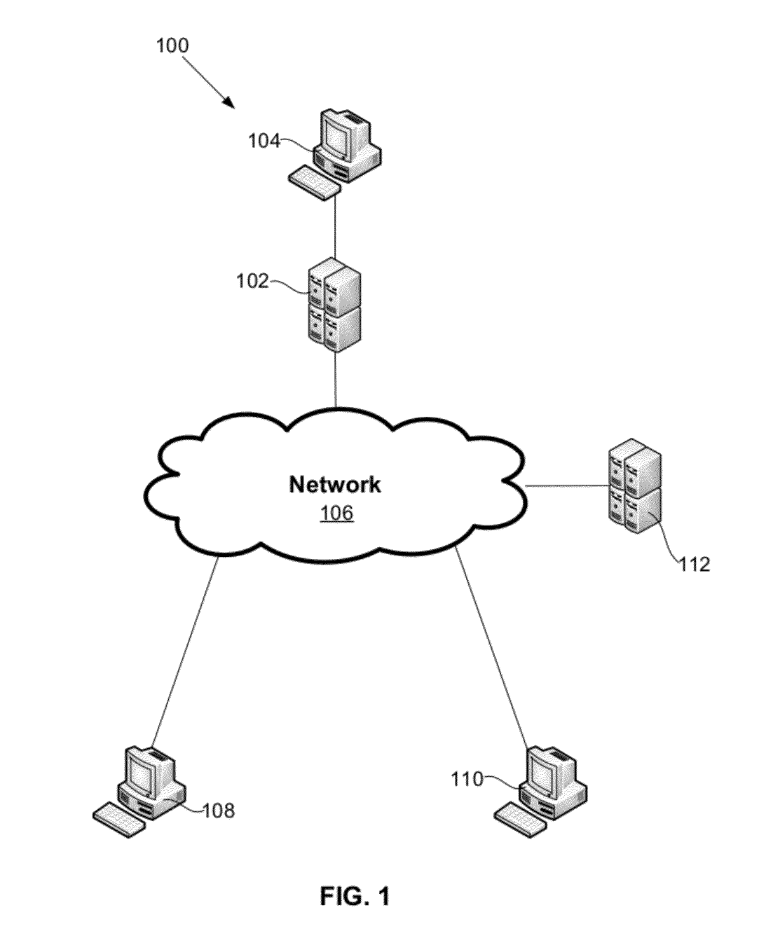

Several embodiments of the invention (as well as environments in which they operate) utilize multiple computers connected over a network, such as the Internet. As shown in FIG. 1, a networked environment 100 may include an operator server 102 and an operator computer 104. The operator server 102 and the operator computer 104 are connected to a network 106, such as the Internet. Also connected to the network 106 are a content generator computer 108, a user computer 110, and a third party server 112. While FIG. 1 depicts a small networked environment, in many embodiments the networked environment 100 may include a plurality of operator servers 102, operator computers 104, networks 106, content generator computers 108, user computers 110, and/or third party servers 112. In several embodiments, the operator server 102 may host online content created by content generators using content generator computers 108 and make that content available to user computers 110 over the Internet.

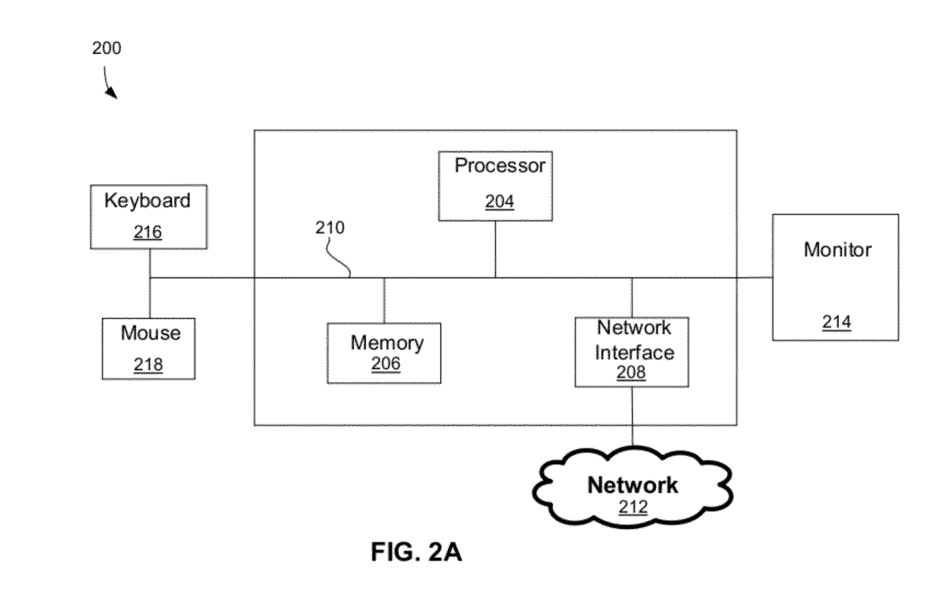

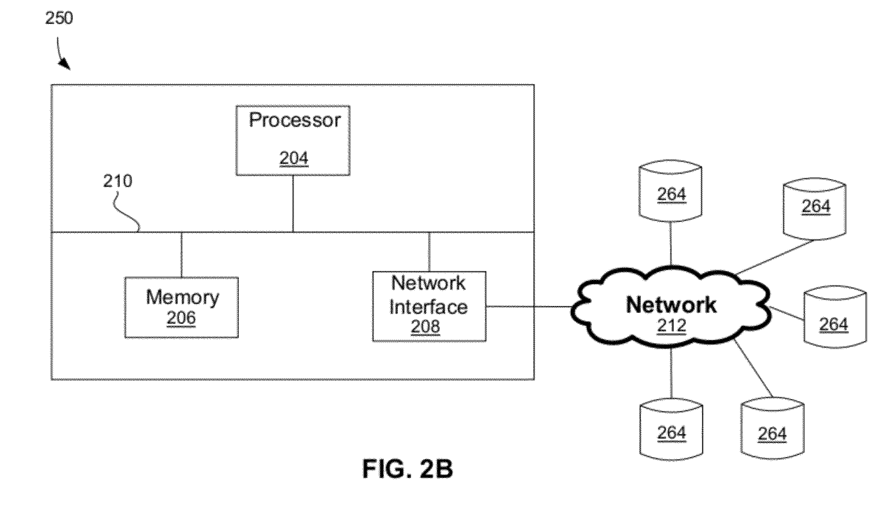

FIG. 2A illustrates portions of a computer system 200, which may in whole or in part serve as an operator computer 104, a content generator computer 108, and/or a user computer 110. The illustrated computer system 200 includes a processor 204 coupled to a memory 206 and a network interface 208 through a bus 210. The network interface 208 is also coupled to a network 212, such as the Internet. The computer system 200 may further include a monitor 214, a keyboard 216, and a mouse 218. In other embodiments, the computer system 200 may use other mechanisms for data input/output and may include a plurality of components (e.g., a plurality of memories 206 or buses 210). FIG. 2B illustrates portions of a computer server 250, which may serve as an operator server 102. The illustrated computer server 250 includes a processor 204 coupled to a memory 206 and a network interface 208 through a bus 210. The network interface 208 is also coupled to a network 212 such as the Internet. In other embodiments, the computer server 250 may include a plurality of components (e.g., a plurality of memories 206 or buses 210). The network 212 may include a remote data storage system including a plurality of remote storage units 264 configured to store data at remote locations. Each remote storage unit 264 may be network accessible storage.

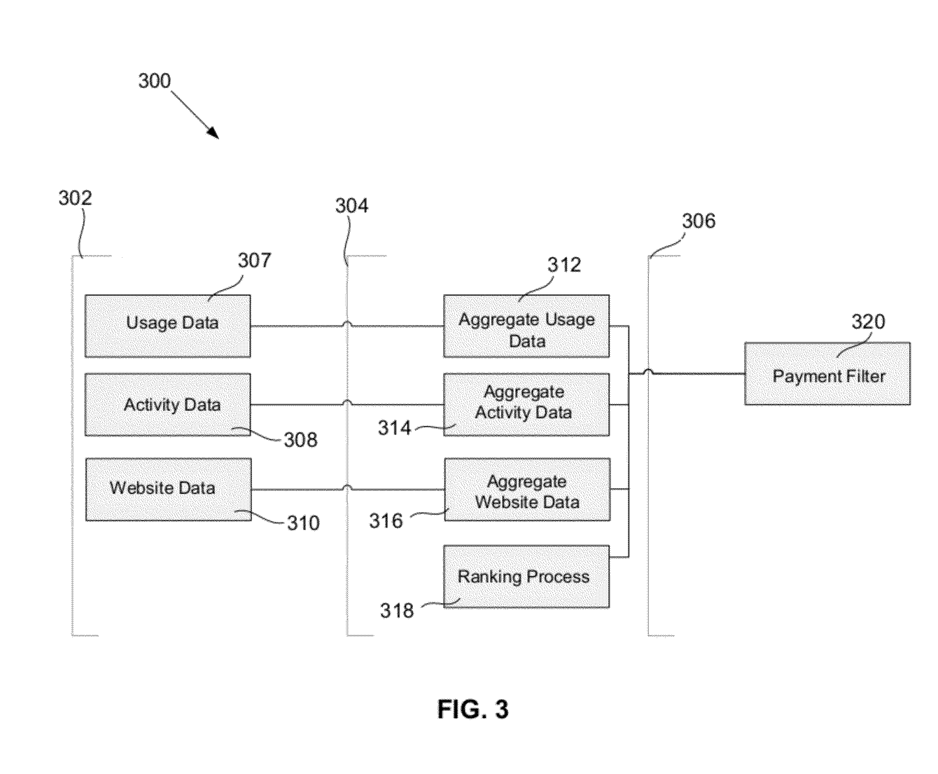

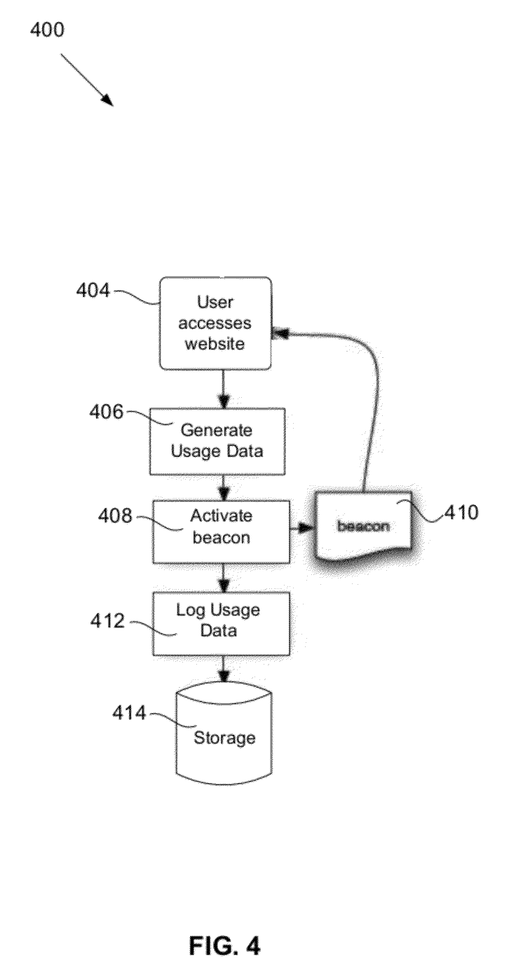

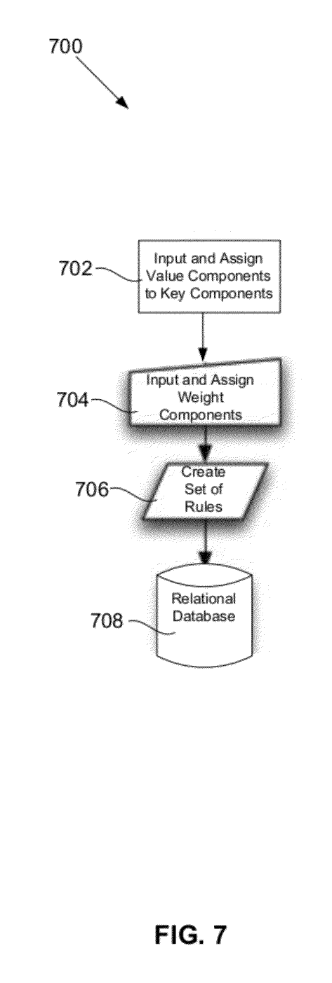

In several embodiments, automated data operations are performed at the operator server 102 and/or the operator computer 104. FIGS. 3-10 depict various steps that may be performed at the operator server 102 and/or operator computer 104. While the data operations shown in FIGS. 3-10 may take place in whole or in part at the operator computer 104, the embodiments described below discuss data operations from the perspective of the operator server 102. In particular, FIG. 3 provides a broad overview of an automated process according to several embodiments, FIGS. 4-6 illustrate steps in the automated process by which the operator server obtains data, and FIGS. 7-10 illustrate steps in the automated process by which the operator server analyzes the data using a set of rules to determine a contributor reward. In some embodiments, the operator may be the entity executing the steps disclosed herein or the entity operating the computers/servers that execute instructions for the steps disclosed herein. For example, the operator may be a website owner desiring to incentivize and reward certain actions of the content generators who generate content for his or her website. To that end, the website owner may use various embodiments of the invention to evaluate the performance of content generators and tailor the set of rules to incentivize or reward particular performances.

As shown in FIG. 3, an automated process 300, according to several embodiments, is separated into three stages: a data ingestion stage 302, a data processing stage 304, and a content generator payment stage 306. The data ingestion stage 302 includes a step of obtaining and storing data related to user interaction with the content (step 307). That data is referred to as “Usage Data,” and may include, for example, the number of user visits to the website containing the content. Greater detail regarding the Usage Data and how it is obtained is provided below. The data ingestion stage 302 also includes a step of obtaining and storing “Activity Data” (step 308), which may include, e.g., data corresponding to user and content generator interactions with the online content on third-party websites. The third-party websites may include social media websites, such as Facebook® or Twitter®, which allow the creation and exchange of user generated content. The Activity Data, as well as the process of harvesting that data, are described in more detail below. In addition, the data ingestion stage 302 may include the collection and storage of data referred to as “Website Data” (step 310). Examples of Website Data include the date that the content was published or a quality review score issued by a peer content generator, and greater detail on step 310 is provided below. In some embodiments, a receiver, which may include, for example, a processor or server, is used to obtain the Usage Data, the Activity Data, and/or the Website Data.

The data processing stage 304 may include steps 312, 314, and 316 in which the Usage Data, the Activity Data, and the Website Data, respectively, are aggregated over a specific time period (e.g., a week). In some embodiments, the Usage Data, the Activity Data, and the Website Data are stored in a repository, which may include a hard disk or other storage medium. The data processing stage 304 also includes a “Ranking Process” 318. In some embodiments, the Ranking Process involves the application of a set of rules that assign a particular value to each data point in the aggregated data set. In some embodiments, the rules also apply weighting factors in order to give greater importance to certain data points and lessen the impact of other data points. For example, the number of times content was accessed may be given more weight than a content generator's ID number. The set of rules may also dictate the amount of reward given to a content generator for his or her performance. In some embodiments, the amount of reward is based on a tiered system, as will be described in more detail below. The application of the set of rules to the various data points may be performed by an evaluator, which may include, for example, a processor in the operator server 102.

In the payment stage 306, the operator server 102 may apply a “Payment Filter” (step 320) to determine whether a content generator receives his or her reward. If payment is authorized, the operator server 102 may send the reward to the content generator through a PayPal® account, for example.

FIG. 4 shows an example process 400 by which the operator server 102 obtains and stores “Usage Data,” which includes user interactions with the content on the website hosting the content. In some embodiments, the operator server 102 uses a “beacon,” e.g., JavaScript in the website, in order to obtain information on how a user interacts with the content. As shown in FIG. 4, a user's browser accesses a website containing the content by requesting an image of the webpage (e.g., examiner.com) from the operator server 102 (step 404). The image request or image call received by the operator server includes information that generates Usage Data (step 406). The image call activates the beacon (step 408), which responds to the user's browser (step 410) and logs the Usage Data (step 412). In some embodiments, the beacon's response to the browser in step 410 and/or user actions with the webpage trigger subsequent interactions between the user's browser and the beacon (i.e., steps 404-408), creating a circular sub-process that results in the acquisition and logging of additional Usage Data. In those embodiments, the browser may send additional image calls that generate additional Usage Data. For example, a user enters a webpage address into his or her browser, which generates and sends an image call to the server hosting that webpage. That image call generates Usage Data. If the user subsequently scrolls to the bottom of the webpage, for example, a minute after the browser loaded the webpage, the browser sends additional image calls that generate the additional Usage Data.

The Usage Data logged by the beacon may then be sent to storage (step 414) for later use. The storage shown in FIG. 4 is merely one example of a storage that may be used with various embodiments of the invention. Examples of Usage Data include data corresponding to: number of page views, counter information, gage information, mouse coordinates of users, time spent on the website or on a particular portion of the website, activity level with mouse moves, scrollbar moves, use of copy and paste function, referrer information (i.e., how the user arrived at the website), geographic attributes of the user, unique user visits, any selections made by a user, a unique ID for the specific instance of the event, an identifier for the type of event, a timestamp, the URL of the website with the content, a referring URL, etc.

In some embodiments, the beacon is present on the website (e.g., examiner.com) residing on operator server 102 in the form of a client-side script (e.g., <script type=text/javascript” src=“http://tracking.examiner.com”>). The script may be hosted externally and may pull in several key data points that constitute Usage Data. In addition to the standard script format, the beacon may incorporate a <noscript> version in a traditional pixel format. In those embodiments, the beacon logs Usage Data based on activity on the website, which is then stored in an external server environment for processing, rather than on production servers or production databases. In some embodiments, the beacon is configured to exclude any robot traffic.

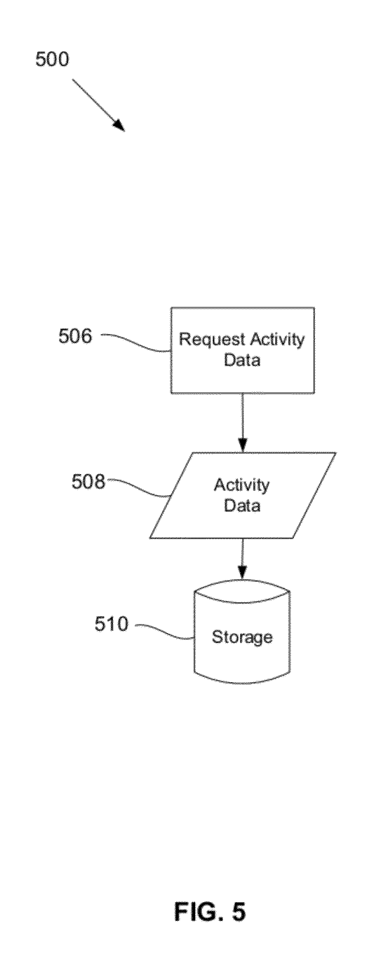

FIG. 5 illustrates an example process 500 by which the operator server 102 obtains and stores “Activity Data,” which may include data corresponding to user and content generator interactions with the online content on the website incorporating the content or on third-party websites, such as Facebook® or Twitter®. A third party website may be any website hosted by a server other than the operator server 102. As shown in FIG. 5, the operator server 102 requests Activity Data from a third party (step 506), receives the Activity Data (step 508) in response to the request, and stores the Activity Data in a storage, e.g., a distributed storage (step 510), for later use. For example, Facebook® provides an API (Application Programming Interface), through which the operator server 102 may obtain metrics or statistics on how many people “liked” a particular website. To use that API, a meta-tag is placed in the root of the website. The website is associated with a Facebook® account, and Facebook® then tracks and records various metrics. Those metrics are subsequently made available through the Facebook® account. In some embodiments, the operator server 102 receives the data from Facebook® in CSV format.

The process shown in FIG. 5 may be repeated in order to obtain data from multiple third-parties. In other embodiments, the operator server 102 may obtain Activity Data without requesting that data from third parties.

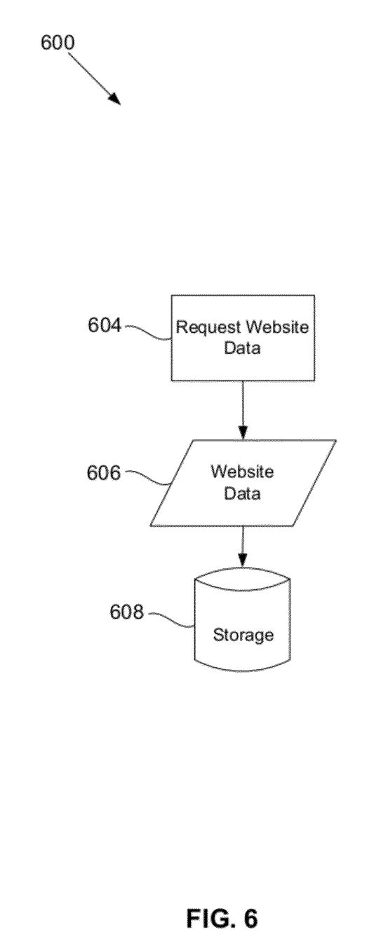

FIG. 6 illustrates a process 600, according to several embodiments, by which the operator server 102 obtains and stores “Website Data,” which may include data related to the content itself, such as data points associated with characteristics of the content. For example, one or more peer content generators may review the content and assign a quality review score to the content. The quality review scores may be stored in a storage, e.g., a distributed database. That storage may include additional information about the content, such as when the content was published, how much content was created, whether the content includes links to related webpages or websites, the content generator's ID, an ID number assigned to the content, whether the content relates to local issues, whether the content is newsworthy, how long the content generator has been creating content, etc. In some embodiments, the Website Data may be stored in the operator server 102, while in other embodiments the Website Data is stored at in a distributed storage system. In the embodiment shown in FIG. 6, the operator server 102 requests Website Data from the database in which the Website Data are stored (step 604). The operator server 102 then receives the Website Data (step 606) and sends it to a storage (step 608).

While the embodiments shown in FIGS. 4-6 depict various databases and storages, in other embodiments data such as Website Data and Usage Data may be directly stored in the memory of the operator server 102. In yet other embodiments, the data obtained by the operator server 102 are stored in a single, distributed data storage system.

Thus, between the Usage Data, the Website Data, and the Activity Data, some examples of data on the operator server 102 may include: “Quality Review Score” (e.g., a single numeric value based on average quality of content); “Length of Service” (e.g., a numeric value based on how long the content generator has been publishing); “Comments” (e.g., a numeric value based on the number of comments posted on the website containing the content); “Number of Subscribers” (e.g., the number of subscribers to the content generated by the content generator); “Number of Shares” (e.g., a numeric value of “Likes” or references to the content provided from Facebook®); “Number of White-listed Referrers” (e.g., a number of referring URLs that are part of a pre-defined white-list); “Number of Internal Links” (e.g., a numeric value representing the number of related links the content generator adds to his/her content); whether the content refers users to other content created in response to a request; whether the content refers users to other content hosted by the operator server 102, the number of users that the content referred to a specific website (e.g., a sponsor's website); “Number of Published Content in last 30 days”; whether the content generator is sponsored; the amount of content created for a particular project; “content rating” (e.g., a numeric value based on an average rating regarding all content); “Average session length from content” (e.g., additional pages viewed after visiting the article); blog network participation; auto-social publishing participation; holiday/time-specific programming; pickups in media/PR; survey completion; and/or mentorship of other content generators, among others.

In several embodiments, use of a set of rules for evaluating the aforementioned obtained data is envisioned. For example, FIG. 7 illustrates an example process 700, according to several embodiments, by which an operator may create the set of rules using, e.g., the operator server 102 or operator computer 104. Each rule may include a key component, a value component, and a weight component. The key component refers to the particular data point (e.g., Quality Review Score) obtained by the operator server 102. As shown in FIG. 7, the operator inputs and assigns one or more value components to various key components or data points (step 702). For example, each data point indicating that a user viewed content for, e.g., one minute may be given a value of, e.g., 0.3. In step 704, the operator inputs and assigns weight components by which certain values are later multiplied when the rules are applied to compute a score. In some embodiments, a value component and a weight component are combined into a single component entered by the operator; in other embodiments, the weight component may be data obtained by the operator server 102, such as the quality review score. Those inputs are used to create the set of rules (step 706), which are stored in a relational database (step 708). In some embodiments, the relational database is part of a distributed data storage system, and the set of rules may be located on a single unit within the distributed system or may be stored in portions of several units of the distributed data system. In other embodiments, the relational database is separate from the storage used for holding the obtained data, such as the distributed data storage system.

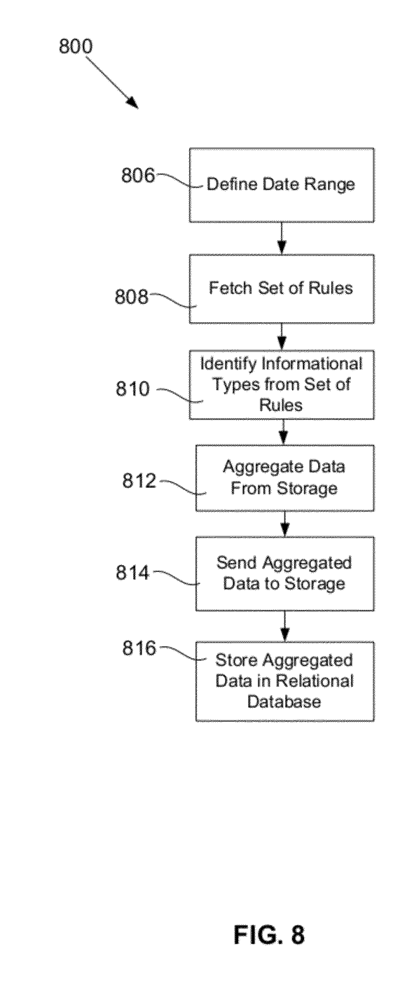

The operator server 102 may perform the Aggregating Data steps (312-316 in FIG. 3) by collecting and consolidating data points corresponding to events that occurred during a specific time period. An example of operations performed during the Aggregating Data steps are shown in more detail in FIG. 8. According to several embodiments, the first step is defining the date range at issue (shown at block 806), which may be entered by an operator into the operator server 102 using the operator computer 104. The second step (shown at block 808) is to fetch the set of rules from a database, which may include the relational database discussed above. The third step (shown at block 810) is to identify informational types (e.g., numbers or strings) of the data that will be aggregated from the key components of the set of rules. The next step (shown at block 812) involves aggregating, or extracting, specific data from the obtained data. For example, the aggregated data may be data points corresponding to the key components identified in the set of rules that occurred during the time period set in step 806. In embodiments in which the obtained data is stored across a distributed storage, that step may be performed through a map reduce phase. Specifically the storages in the distributed storage emit the obtained data, and the data is condensed, or reduced. In some embodiments, the steps in the map reduce phase are performed in parallel for each key component and the results are placed in storage, while in other embodiments the map reduce phase is performed for all the key components in series. The aggregated data may be stored in a distributed storage (as shown in block 814) as a cache and may also be sent to the relational database (block 816) for later use.

Placing the aggregated data in cache storage allows subsequent computations to run more efficiently. For example, if the operator changes the relevant date range, adds additional data points, or modifies a rule in the set of rules, the operator server 102 may simply pull data points from the cache storage for those key components that are unaffected by the change. In addition, the operator server 102 can track data points from one time frame to another using the data points in the cache storage. This permits the operator to trace every value that is used to calculate the content generator's reward. Performing the Aggregating Data steps using a distributed system is merely one embodiment; the obtained data may be stored in any database that can be queried and/or from which data may be retrieved. Likewise, the output of the Aggregating Data steps may be stored in any database that can be queried and/or from which data may be retrieved. In embodiments in which the data are stored in a single database, the relevant data may be aggregated without using a map reduce phase. In addition, the data may be sent directly to the relational database without being cached in, e.g., a distributed storage.

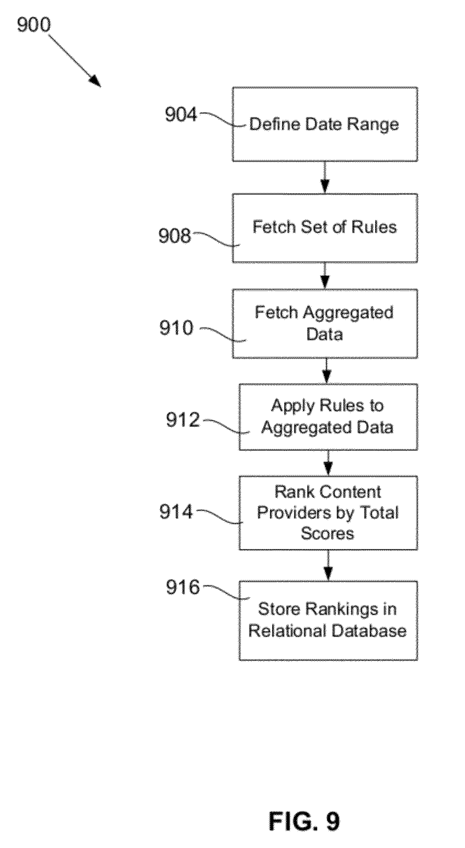

Once the relevant data are aggregated, the operator server 102 may perform the Ranking Process step (318 in FIG. 3), which is shown in more detail in FIG. 9. In some embodiments, that process may begin by defining the date range at issue (step 904), which may be the same date range defined in step 806. Next, the set of rules are fetched from the relational data base (step 908). The aggregated data are also fetched from the relational database (step 910). In step 912, the set of rules is applied to the aggregated data. Specifically, in this step the data corresponding to a key component and a value component associated with that key component create a value that is multiplied by the associated weighting component to create a score. The score for each key component is then summed to compute a total score. For example, one key component may be the number of “subscribers,” which includes users that sign up to receive updates whenever new material is published on the website by the content generator. If the number of subscribers is, for example, 300, and the value component for each subscriber is, for example, 0.3 with a weight component of, for example, 10, the score for the “subscribers” key component would be 300*0.3*10, or 900. That key component score will be added to the key component scores for the remaining key components for a total content generator score. In some embodiments, the quality review score is used as a weight component rather than as a key component and may be applied to the total content generator score or to a sum of some of the key component values. In step 914 each content generator is ranked with respect to other content generators based on the total scores. The rankings may then be stored into the relational database (step 916).

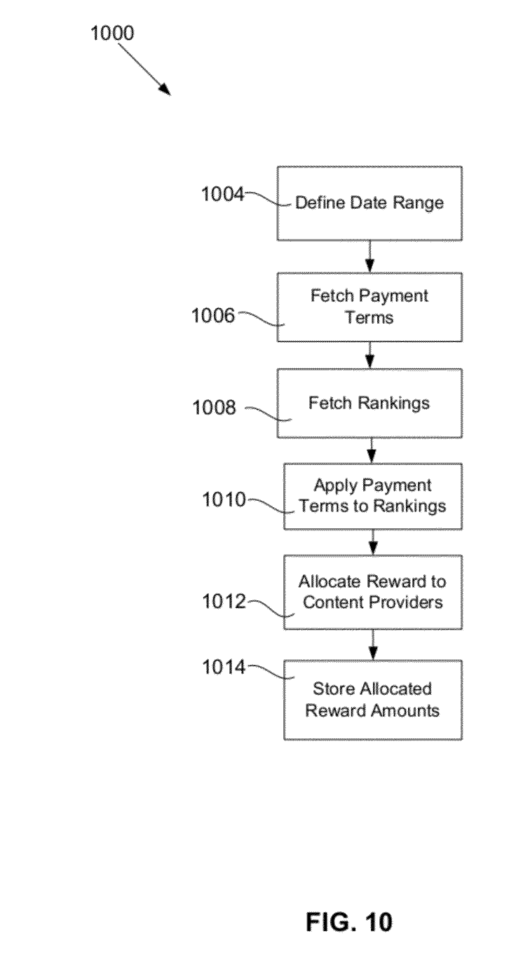

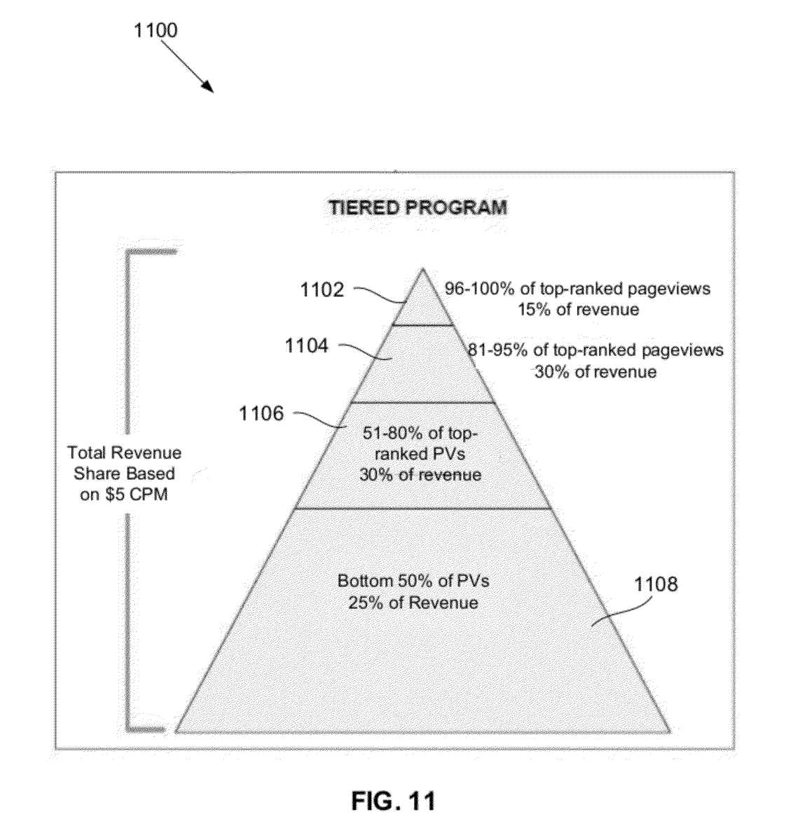

The payment stage may include an example process 1000, as shown in FIG. 10, which may be performed by the operator server 102. In those embodiments, the operator server 102 begins by defining the data range at issue (step 1004). The operator server 102 then fetches payment terms for distributing rewards (step 1006). Exemplary payment terms are shown in FIG. 11 and are described in more detail below. In some embodiments, the payment terms are stored in the relational database and are retrieved during the process 1000. The operational server 102 also fetches the rankings stored in the relational database (step 1008). In step 1010, the payment terms are applied to the rankings and, in step 1012, a reward is allocated to each content generator. The amount of the allocated reward for each content generator is then stored in the relational database (step 1014).

In some embodiments, payment terms are configured to produce a tiered payout, as illustrated in the example of FIG. 11. In that example, the total reward allocated to content generators is based on revenue. In some embodiments, the total reward may be a predetermined amount that may or may not be related to revenue, while in other embodiments, the total reward amount is not set but varies according to the sum of the scores of the individual content generators. In the example of FIG. 11, the top 5% of content generators, according to their total scores, may share 15% of the revenue as shown in tier I (1102). The next 15% of content generators, according to the weighted rankings, may share 30% of the revenue as shown in tier II (1104). Similarly, the next 30% of content generators, according to the weighted rankings, may share 30% of the revenue as shown in tier III (1106), with the bottom 50% of content generators, according to the weighted rankings, splitting 25% of the revenue as shown in tier IV (1108). In other embodiments, the tiers may be further divided into sub-tiers. For example, those content generators located near the top of tier II may receive a greater reward than those at the bottom of tier II but still less than those at the bottom of tier I.

In other embodiments, the payment terms allocate a reward based on the obtained data without ranking the content generators. For example, a content generator may be given a specific monetary amount for each time his or her content refers to related content by another content generator or for each Facebook® “like” involving the content.

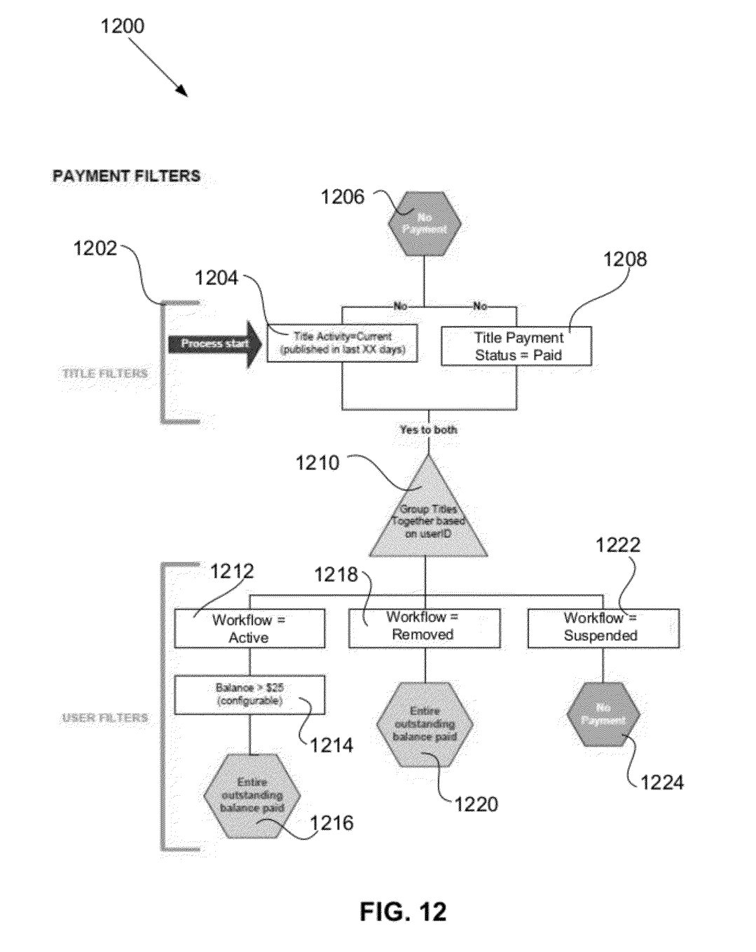

A payment filter process 1200, as shown in FIG. 12, may also be implemented according to embodiments of the invention. The process 1200 may begin with an inquiry as to whether an article was published within a certain time frame (step 1204) or whether the content generator is entitled to receive pay (step 1208). If the response to either inquiry is negative, no payment is allocated (step 1206). If both inquiries receive positive responses, then the process proceeds to group payment data according to a content generator's ID (step 1210). Next, an inquiry is made into the “workflow” status of the content generator. In some embodiments, each content generator may be placed into one of three categories: Active, Removed, or Suspended. Those categories are merely examples, and any number or type of categories may be used. If the content generator is in the active category, and if the balance of the reward due to that content generator is greater than $25, then the entire outstanding balance is paid (steps 1212-1216). If the content generator has been removed from the system, then the entire outstanding balance is paid (steps 1218-1220). If the content generator's status is placed in suspension, then no payment issues (steps 1222-1224).

In other embodiments, the operator computer 104 may include an operator program with which the operator may modify the set of rules and/or settings of the automated process.

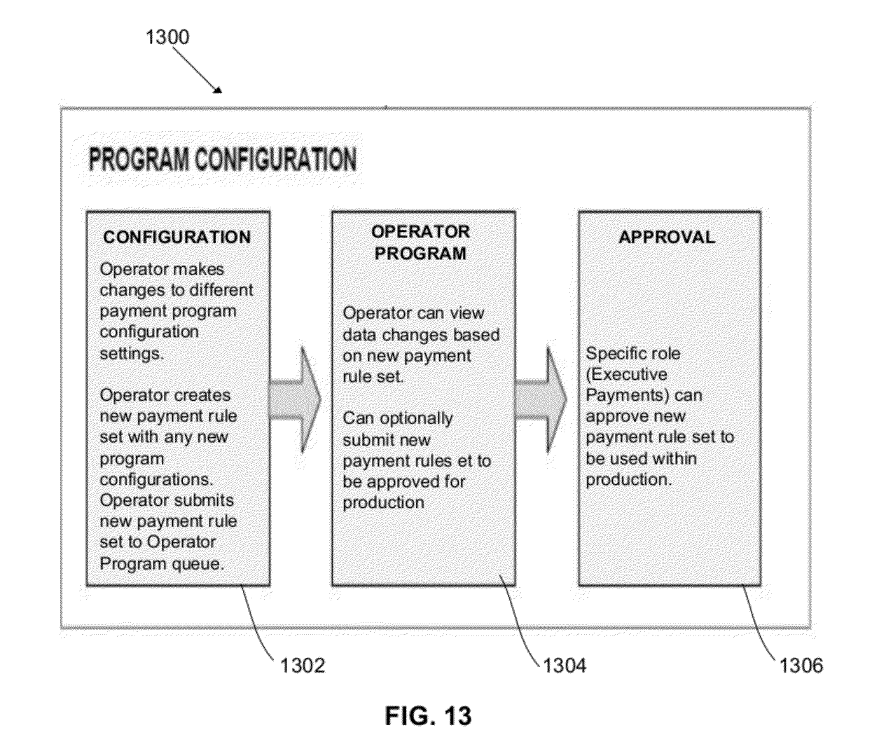

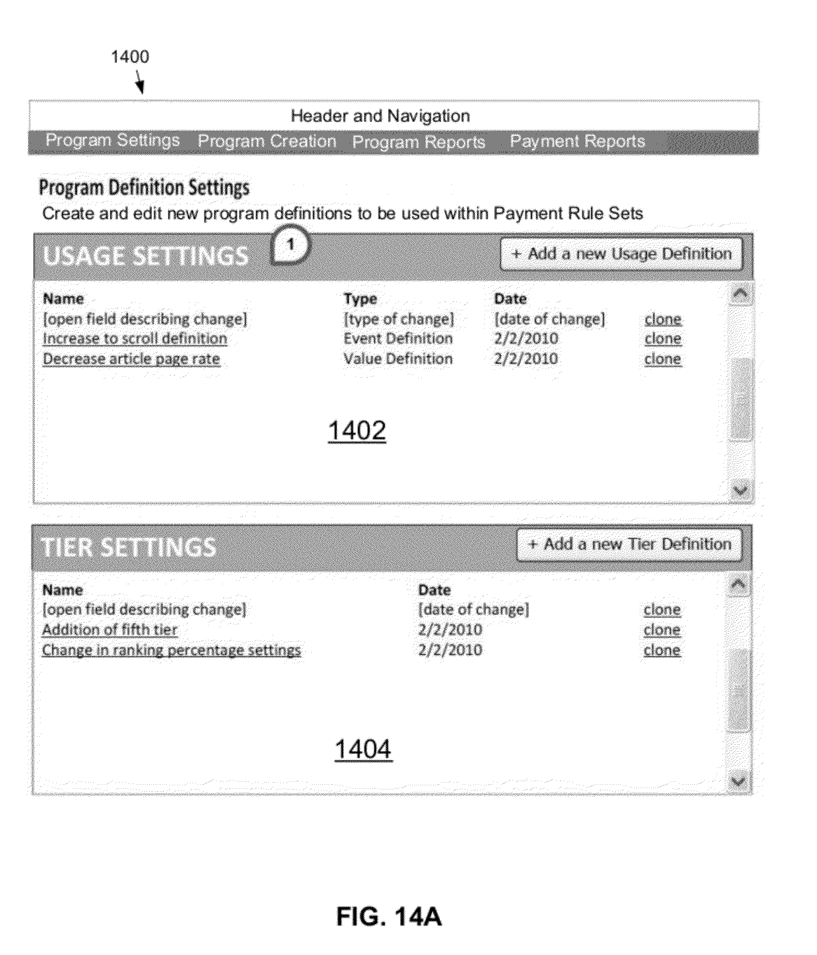

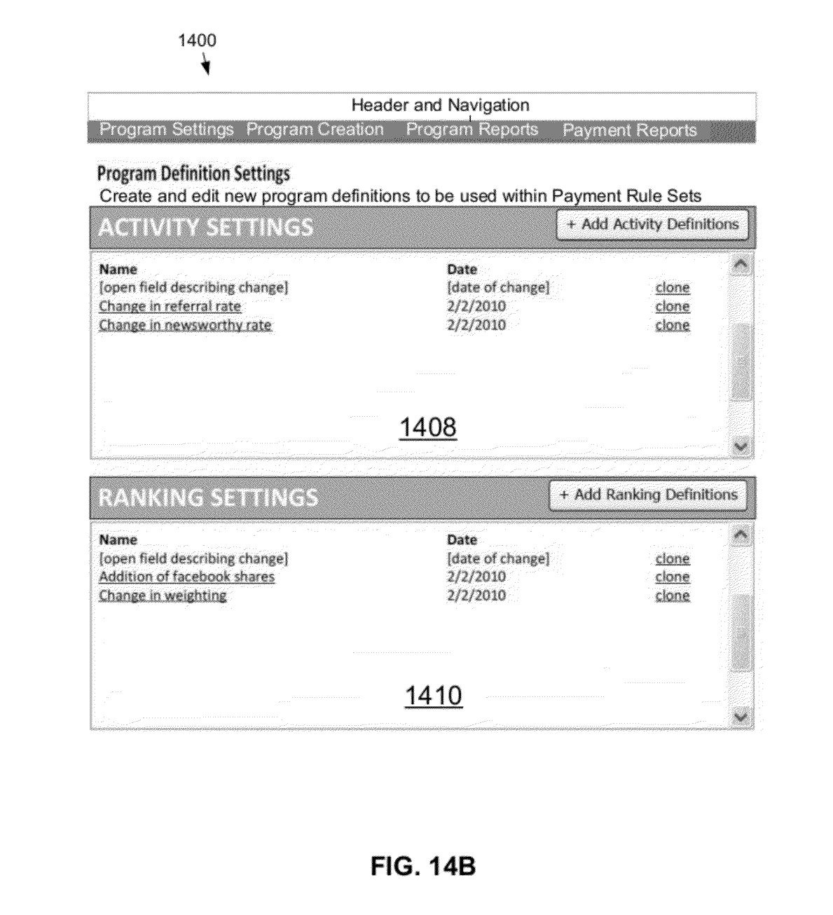

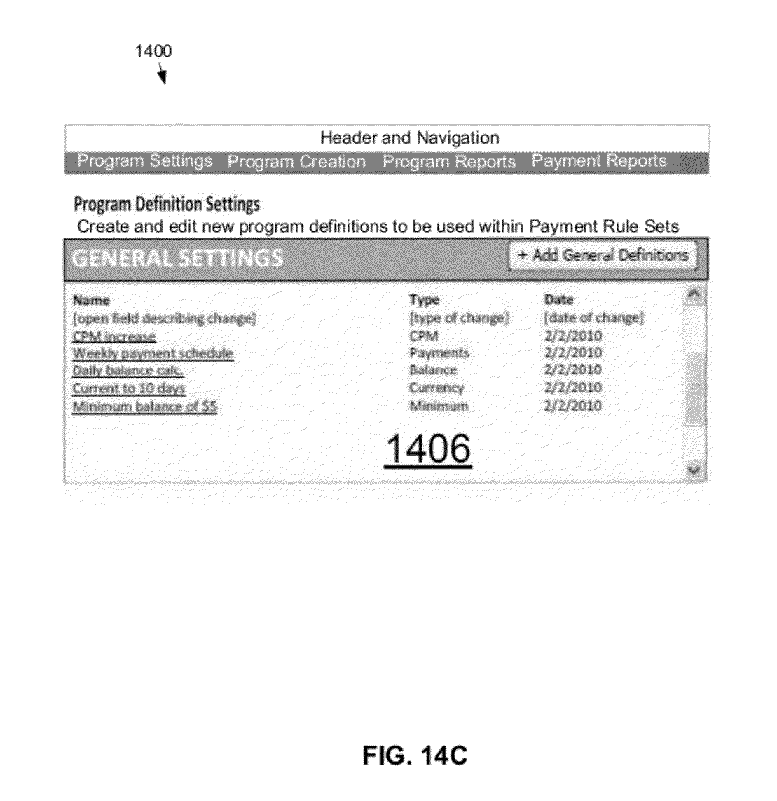

While exemplary operator programs are discussed in FIGS. 13-14, any program with similar functions may be used. In the embodiment shown in FIG. 13, an operator program configuration process 1300 involves implementing a change to the automated program (e.g., a modification to an element in the set of rules or an additional rule to the set of rules) as shown in block 1302. In some embodiments, the automated system determines content generator compensation using the modified set of rules and may display the results along with the content generator compensation determined with the original set of rules, as shown in block 1304. The program may then provide the option of approving or rejecting the changes after reviewing the results, as shown in block 1306.

FIG. 14 depicts an operator program 1400 according to several embodiments. Operator program 1400 enables an operator to change a number of settings or add new definitions and/or settings. For example, the operator program may enable the operator to add and define a “usage definition” that corresponds to a key component and also to assign a value to that key component. The operator program may also enable the operator to define a monetary reward for particular events. For example, the number of referrals in the content (e.g., references or hyperlinks to content created by other content generators and hosted by the operator server 102) may be assigned a specific dollar amount. Other options enabled by the operator program may include creating an “Examiner Ranking Definition Set,” which may be a part of the set of rules that assigns particular point values to various key components.

In those embodiments using a tiered payment system, the operator program may also enable the operator to define the boundaries and reward amounts for each tier. The operator may use the operator program to automatically evaluate a content generator's performance using the processes described above.

The operator program 1400 may further enable an operator to input the reporting period as well as verify and/or alter the settings of the operator program 1400. The operator program 1400 may generate reports that include, for example, the amount of content generated by one or more content generators, titles of the content, and payments that were allocated to each payment tier and/or to each content generator. The reports may also include information from prior evaluations. In some embodiments, the reports detail the status of various automated processes that are ongoing and/or previously completed.

In some embodiments, a computer-readable medium contains instructions that cause a processor to perform many of the functions described above. The medium may include a hard drive, a disk, memory, or a transmission, among other computer-readable mediums.

Various modifications and additions can be made to the embodiments discussed without departing from the scope of the present invention. For example, while the embodiments described above refer to particular features, the scope of this invention also includes embodiments having different combinations of features and embodiments that include different features or do not include all of the described features. Accordingly, the scope of the present invention is intended to embrace all such alternatives, modifications and variations.

We claim:

1. A computer-based system configured to automatically evaluate a content generator, comprising:
a receiver configured to obtain a first set of data comprising Usage Data that corresponds to user interactions with content provided by the content provider on a website incorporating the content, a second set of data comprising Activity Data that corresponds to user and content provider interactions with the content on third party websites, and a third set of data comprising Website Data that corresponds to information regarding characteristics of the content;
a repository configured to store the first, second, and third sets of data; and
an evaluator configured to determine a level of positive contribution of the content generator by analyzing the first set of data, the second set of data, and the third of data using a set of rules.

2. The computer-based system of claim 1, wherein the Usage Data includes data corresponding to the number of page views, wherein the Activity Data includes data corresponding to user comments on third-party websites regarding the content, and wherein the Website Data includes data corresponding to the content generator's ID.

3. The computer-based system of claim 1, wherein the Website Data includes a peer-review quality score.

4. The system of claim 1, wherein the set of rules includes a set of value components and a set of key components, and wherein each value component in the set of value components is associated with a key component.

5. The system of claim 4, wherein the evaluator is configured to create analysis data by applying the set of value components and the set of key components to the first, second, and third sets of data, and wherein the evaluator is configured to store the analysis data in the repository.

6. The system of claim 5, wherein the evaluator is configured to re-analyze the first set of data, the second set of data, and the third set of data when an element of the set of rules is changed by obtaining at least one data point of the analysis data that is unaffected by the changed element from the repository and by analyzing affected portions of the first set of data, the second set of data, and the third set of data using the changed set of rules.

7. The system of claim 1, wherein the first set of data includes data from a beacon operating on the website incorporating the content.

8. A computer-implemented method for automatically evaluating generator performance based on generated content, comprising:
obtaining a first set of data comprising data points corresponding to Website Data;
obtaining a second set of data comprising data points corresponding to Usage Data;
obtaining a third set of data comprising data points corresponding to user interactions with the generated content on third-party websites;
analyzing the first set of data, the second set of data, and the third set of data using a set of rules, wherein the set of rules comprise at least one key component; and
determining a level of positive contribution based on the analysis of the first set of data, the second set of data, and the third of data using the set of rules.

9. The computer-implemented method of claim 8, wherein the third set of data includes data points corresponding to generator interactions with the generated content on third-party websites.

10. The computer-implemented method of claim 8, wherein obtaining the second set of data includes obtaining data from a beacon operating on a website incorporating the generated content.

11. The computer-implemented method of claim 10, wherein the data obtained from the beacon includes a URL of a second website that referred the user to the website incorporating the generated content.

12. The computer-implemented method of claim 10, wherein the website incorporating the generated content is hosted by a server, and wherein obtaining the first set of data includes obtaining data corresponding to references in the generated content to other content hosted by the server.

13. The computer-implemented method of claim 8, wherein obtaining the first set of data includes obtaining data corresponding to a quality review score.

14. The computer-implemented method of claim 8, wherein the set of rules further comprise at least one value component.

15. The computer-implemented method of claim 14, wherein each value component of the at least one value component is associated with a key component of the at least one key component.

16. The computer-implemented method of claim 15, wherein the set of rules further comprise at least one weight component, wherein obtaining the first set of data includes obtaining data corresponding to a quality review score, and wherein the at least one weight component utilizes the quality review score.

17. The computer-implemented method of claim 8, wherein determining the level of positive contribution includes:
ranking the content generator against other content generators, based on the set of rules; and
determining the level of positive contribution using the content generator rankings.

18. The computer-implemented method of claim 8, wherein the first set of data includes data corresponding to an amount of online content generated by the content generator in a defined time period.

19. The computer-implemented method of claim 8, wherein the second set of data includes data corresponding to a quantity of subscribers to online content generated by the content generator.

20. A computer-readable medium containing instructions that cause a processor to perform the following:
obtain a first set of data associated with a publication of online content generated by a content generator;
obtain a second set of data corresponding to user interactions with a website incorporating the generated content;
obtain a third set of data corresponding to user and content generator interactions with the generated content on at least one third-party website;
evaluate the performance of a content generator by applying a set of key components and a set of value components in a set of rules to the first set of data, the second set of data, and the third set of data.

21. The computer-readable medium of claim 20, wherein the instructions cause the processor to rank the content generator against other content generators.

22. The computer-readable medium of claim 20, wherein the at least one third-party website includes a social media website.
